(19) United States
(12) Patent Application Publication
(10) Pub. No.: US 2010/0302782 A1
(43) Pub. Date: Dec. 2, 2010

(54) LIGHT-EMITTING DEVICE

(75) Inventor: Akihiro ANZAI, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/785,804

(22) Filed: May 24, 2010

(30) Foreign Application Priority Data
May 29, 2009 (JP) 2009-131196

(51) Int. Cl. F21V 13/04

(52) U.S. Cl. 362/308

(57) ABSTRACT

A light-emitting device is obtained by disposing a reflective layer on a GaAs substrate, by disposing a light-emitting layer on the reflective layer, and by disposing a surface layer on the light-emitting layer. The surface layer is formed by alternately stacking a low refractive film and a high refractive film having a refractive index higher than that of the low refractive film. The surface layer may be formed by alternately stacking one low refractive film and one high refractive film. The outermost film in the surface layer may be the low refractive film. The film adjacent to the light-emitting layer in the surface layer may be the high refractive film.

### CROSS-REFERENCE TO RELATED APPLICATION

This application is based upon and claims the benefit of priority from Japanese Patent Application No. 2009-131196 filed on May 29, 2009, of which the contents are incorporated herein by reference.

### BACKGROUND OF THE INVENTION

1. Field of the Invention

The present invention relates to a light-emitting device, for example, a light-emitting device suitable for a surface light-emitting diode.

2. Description of the Related Art

When the emission light amount of a light-emitting device is increased, the power consumption, the number of the devices, and the number of wirings are generally reduced, thereby resulting in cost reduction. A method for increasing the emission light amount contains formation of a reflective layer below an active layer to increase the light output (see Japanese Laid-Open Patent Publication No. 09-289336).

However, when the reflective layer is formed in a device having a large overall thickness such as a light-emitting diode, a resonance is often caused between the reflective layer and an air space or surface layer. Though the emission light amount of the device is increased by the reflective layer, the emission wavelength of the device is shifted due to thickness nonuniformity caused in a production process, whereby the devices vary considerably in the emission light amount disadvantageously.

Furthermore, the devices having different thicknesses exhibit different emission wavelength shift amounts under heating condition, whereby the emission light amount variation is further increased in use.

Thus, when such light-emitting devices are used in a display or an exposure apparatus having a plurality of light-emitting portions, approximately uniform light emission cannot be easily obtained over the entire display or exposure surface. Obviously the emission light amount variation among the devices can be reduced by a light amount correction technique. However, it is extremely difficult to completely eliminate the emission light amount variation, and many processes are required for detecting the emission property of each light-emitting portion, resulting in cost increase.

### SUMMARY OF THE INVENTION

In view of the above problems, an object of the present invention is to provide a light-emitting device, which exhibits a reduced emission light amount variation in use, an increased yield, and an improved quality, and can be used for producing a product with an increased yield and an improved quality.

According to a first aspect of the present invention, there is provided a light-emitting device comprising a light-emitting layer, a reflective layer formed on one side of the light-emitting layer, and a surface layer formed on the other side of the light-emitting layer, wherein a light from the light-emitting layer is reflected by the reflective layer, and at least a light from the light-emitting layer and a light from the reflective layer are transmitted through the surface layer, so that a light is emitted from the surface layer, and the surface layer is formed by alternately stacking a low refractive film and a high refractive film having a refractive index higher than that of the low refractive film.

In the aspect, the emission light amount variation among the light-emitting devices in use can be reduced in use, and the yield and quality of the light-emitting device per se can be improved. Therefore, for example, when the light-emitting device of the present invention is used in a display or an exposure apparatus having a plurality of light-emitting portions, approximately uniform emission light amount can be obtained over the entire display or exposure surface without light amount correction techniques. Thus, processes for detecting the emission property of each light-emitting portion are not needed, whereby the yield and quality of a product using the light-emitting device can be improved. As a result, the product using the light-emitting device can be obtained with reduced cost.

In the present invention, the surface layer may be formed by alternately stacking one low refractive film and one high refractive film.

In the present invention, the light-emitting layer may have a thickness of 1.5 μm to 5.0 mm.

In the present invention, the outermost film in the surface layer may be the low refractive film.

In the present invention, the film adjacent to the light-emitting layer in the surface layer may be the high refractive film.

In the light-emitting device according to the present invention, the surface layer may have a two-film structure containing a first film adjacent to the light-emitting layer, and a second film, the first film has an optical path length of n1×d1, the second film has an optical path length of n2×d2, and the optical path lengths of n1×d1 and n2×d2 are within a range enclosed by the following coordinates.
(n1×d1, n2×d2)=(300, 241)
(n1×d1, n2×d2)=(300, 273)
(n1×d1, n2×d2)=(240, 241)
(n1×d1, n2×d2)=(100, 498)
(n1×d1, n2×d2)=(100, 546)
(n1×d1, n2×d2)=(160, 546)

In the light-emitting device according to the present invention, the surface layer may have a two-film structure containing a first film adjacent to the light-emitting layer, and a second film, the first film has an optical path length of n1×d1, the second film has an optical path length of n2×d2, and the optical path lengths of n1×d1 and n2×d2 are within a range enclosed by the following coordinates.
(n1×d1, n2×d2)=(280, 642)
(n1×d1, n2×d2)=(280, 691)
(n1×d1, n2×d2)=(240, 642)
(n1×d1, n2×d2)=(160, 915)
(n1×d1, n2×d2)=(100, 915)

In the light-emitting device according to the present invention, the surface layer may have a two-film structure containing a first film adjacent to the light-emitting layer, and a second film, the first film has an optical path length of n1×d1, the second film has an optical path length of n2×d2, and the optical path lengths of n1×d1 and n2×d2 are within a range enclosed by the following coordinates.
(n1×d1, n2×d2)=(260, 1060)
(n1×d1, n2×d2)=(260, 1092)
(n1×d1, n2×d2)=(220, 1060)
(n1×d1, n2×d2)=(180, 1285)
(n1×d1, n2×d2)=(120, 1285)

In the light-emitting device according to the present invention, the surface layer may have a two-film structure containing a first film adjacent to the light-emitting layer, and a second film, the first film has an optical path length of n1×d1, the second film has an optical path length of n2×d2, and the optical path lengths of n1×d1 and n2×d2 are within a range enclosed by the following coordinates.
(n1×d1, n2×d2)=(200, 80)
(n1×d1, n2×d2)=(100, 80)
(n1×d1, n2×d2)=(140, 161)
(n1×d1, n2×d2)=(100, 161)

In the light-emitting device according to the present invention, the surface layer has a three-film structure containing first, second and third films, the first film being adjacent to the light-emitting layer, the first film has an optical path length of n1×d1, the second film has an optical path length of n2×d2, the optical path length of the third film is ½ of the emission wavelength or a multiple thereof, and the optical path lengths of n1×d1 and n2×d2 are within a range enclosed by the following coordinates.
(n1×d1, n2×d2)=(80.3, 90.0)
(n1×d1, n2×d2)=(80.3, 110.0)
(n1×d1, n2×d2)=(58.4, 90.0)
(n1×d1, n2×d2)=(7.3, 150.0)
(n1×d1, n2×d2)=(7.3, 190.0)
(n1×d1, n2×d2)=(29.2, 190.0)

In the light-emitting device according to the present invention, the surface layer has a three-film structure containing first, second and third films, the first film being adjacent to the light-emitting layer, the first film has an optical path length of n1×d1, the second film has an optical path length of n2×d2, the optical path length of the third film is ½ of the emission wavelength or a multiple thereof, and the optical path lengths of n1×d1 and n2×d2 are within a range enclosed by the following coordinates.
(n1×d1, n2×d2)=(102.2, 60.0)
(n1×d1, n2×d2)=(102.2, 80.0)
(n1×d1, n2×d2)=(80.3, 60.0)
(n1×d1, n2×d2)=(7.3, 140.0)
(n1×d1, n2×d2)=(7.3, 190.0)
(n1×d1, n2×d2)=(21.9, 190.0)

In the light-emitting device according to the present invention, the surface layer has a four-film structure containing first, second, third and fourth films, the first film being adjacent to the light-emitting layer, the first film has an optical path length of n1×d1, the second film has an optical path length of n2×d2, the sum of the optical path lengths of the third and fourth films is approximately equal to the emission wavelength, and the optical path lengths of n1×d1 and n2×d2 are within a range enclosed by the following coordinates.
(n1×d1, n2×d2)=(109.5, 43.8)
(n1×d1, n2×d2)=(109.5, 87.6)
(n1×d1, n2×d2)=(80.3, 43.8)
(n1×d1, n2×d2)=(58.4, 350.4)
(n1×d1, n2×d2)=(29.2, 350.4)

In the light-emitting device according to the present invention, the surface layer has a five-film structure containing first, second, third, fourth and fifth films, the first film being adjacent to the light-emitting layer, the first film has an optical path length of n1×d1, the second film has an optical path length of n2×d2, the optical path length of the third film is approximately equal to ¼ of the emission wavelength, the sum of the optical path lengths of the fourth and fifth films is approximately equal to the emission wavelength, and the optical path lengths of n1×d1 and n2×d2 are within a range enclosed by the following coordinates.
(n1×d1, n2×d2)=(102.2, 60.0)
(n1×d1, n2×d2)=(102.2, 80.0)
(n1×d1, n2×d2)=(80.3, 60.0)
(n1×d1, n2×d2)=(7.3, 140.0)
(n1×d1, n2×d2)=(7.3, 190.0)
(n1×d1, n2×d2)=(29.2, 190.0)

In the light-emitting device according to the present invention, the surface layer has a five-film structure containing first, second, third, fourth and fifth films, the first film being adjacent to the light-emitting layer, the first film has an optical path length of n1×d1, the second film has an optical path length of n2×d2, the optical path length of the third film is approximately equal to ¼ of the emission wavelength, the sum of the optical path lengths of the fourth and fifth films is approximately equal to the emission wavelength, and the optical path lengths of n1×d1 and n2×d2 are within a range enclosed by the following coordinates.
(n1×d1, n2×d2)=(116.8, 60.0)
(n1×d1, n2×d2)=(116.8, 80.0)
(n1×d1, n2×d2)=(87.6, 60.0)
(n1×d1, n2×d2)=(7.3, 150.0)
(n1×d1, n2×d2)=(7.3, 190.0)
(n1×d1, n2×d2)=(29.2, 190.0)

In those cases, the surface layer can show an average transmittance of at least 94% or 97%, the emission light amount variation among the light-emitting devices can be reduced, and the reflective layer can be sufficiently effective for increasing the emission light amount.

As described above, the light-emitting device of the present invention can have a reduced emission light amount variation in use, an increased yield, and an improved quality, and can be used for producing a product with improved yield and quality.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a cross-sectional view partly showing a principal part of a light-emitting device according to an embodiment of the present invention;

FIG. 2A is a cross-sectional view showing a principal part of a light-emitting device of Comparative Example;

FIG. 2B is a cross-sectional view showing a principal part of a light-emitting device of Example;

FIG. 3 is a graph showing the emission light amount increase-decrease ratio depending on the emission wavelength in the light-emitting device of Comparative Example;

FIG. 4A is a graph showing the emission light amount change of Comparative Example depending on the emission wavelength in a case where the overall thickness of the light-emitting device was 1% smaller than the predetermined thickness;

FIG. 4B is a graph showing the emission light amount change of Comparative Example depending on the emission wavelength in a case where the overall thickness of the light-emitting device was 1% larger than the predetermined thickness;

FIG. 5 is a graph showing the emission light amount increase-decrease ratio depending on the emission wavelength in the light-emitting device of Example;

FIG. 6A is a graph showing the emission light amount change of Example depending on the emission wavelength in a case where the overall thickness of the light-emitting device was 1% smaller than the predetermined thickness;

FIG. 6B is a graph showing the emission light amount change of Example depending on the emission wavelength in a case where the overall thickness of the light-emitting device was 1% larger than the predetermined thickness;

FIG. 7 is a graph showing the transmittance changes of Comparative Example 1 and Examples 1 to 4 depending on the emission wavelength;

FIG. 8 is a graph showing the transmittance changes of Comparative Example 1 and Examples 5 to 8 depending on the emission wavelength;

FIG. 9 is a graph showing a surface layer transmittance distribution of Example 9 using parameters of optical path lengths of first and second films (in an area with n1×d1 of 100 to 300 and n2×d2 of 80 to 193);

FIG. 10 is a graph showing a surface layer transmittance distribution of Example 9 (in an area with n1×d1 of 100 to 300 and n2×d2 of 193 to 578);

FIG. 11 is a graph showing a surface layer transmittance distribution of Example 9 (in an area with n1×d1 of 100 to 300 and n2×d2 of 578 to 980);

FIG. 12 is a graph showing a surface layer transmittance distribution of Example 9 (in an area with n1×d1 of 100 to 300 and n2×d2 of 980 to 1365);

FIG. 13 is a graph showing a surface layer transmittance distribution of Example 10 using an outermost third film having a thickness of approximately 530 nm (an optical path length n3×d3 of 777) and parameters of optical path lengths n1×d1 and n2×d2 of first and second films (in an area with n1×d1 of 7.3 to 138.7 and n2×d2 of 10 to 190);

FIG. 14 is a graph showing a surface layer transmittance distribution of Example 10 using an outermost third film having a thickness of approximately 270 nm (an optical path length n3×d3 of 394) and parameters of optical path lengths n1×d1 and n2×d2 of first and second films (in an area with n1×d1 of 7.3 to 138.7 and n2×d2 of 10 to 190);

FIG. 15 is a graph showing a surface layer transmittance distribution of Example 11 using a fourth film having an optical path length n4×d4 of 584, a third film having an optical path length n3×d3 of 196, and parameters of optical path lengths n1×d1 and n2×d2 of first and second films (in an area with n1×d1 of 7.3 to 138.7 and n2×d2 of 21.9 to 416.1);

FIG. 16 is a graph showing a surface layer transmittance distribution of Example 12 using a fifth film having an optical path length n5×d5 of 584, a fourth film having an optical path length n4×d4 of 196, a third film having an optical path length n3×d3 of 195, and parameters of optical path lengths n1×d1 and n2×d2 of first and second films (in an area with n1×d1 of 7.3 to 138.7 and n2×d2 of 10 to 190); and

FIG. 17 is a graph showing a surface layer transmittance distribution of Example 12 using a fifth film having an optical path length n5×d5 of 555, a fourth film having an optical path length n4×d4 of 170, a third film having an optical path length n3×d3 of 165, and parameters of optical path lengths n1×d1 and n2×d2 of first and second films (in an area with n1×d1 of 7.3 to 138.7 and n2×d2 of 10 to 190).

### DESCRIPTION OF THE PREFERRED EMBODIMENTS

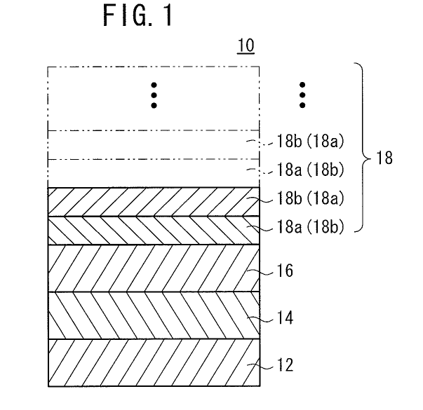

An embodiment of using the light-emitting device of the present invention in a surface light-emitting diode will be described below with reference to FIGS. 1 to 17.

As schematically shown in FIG. 1, a light-emitting device 10 according to the embodiment is formed by stacking a reflective layer 14 on a GaAs substrate 12, by stacking a light-emitting layer 16 on the reflective layer 14, and by stacking a surface layer 18 on the light-emitting layer 16. In other words, the light-emitting device 10 has the light-emitting layer 16, the reflective layer 14 formed on one side of the light-emitting layer 16, and the surface layer 18 formed on the other side of the light-emitting layer 16. A light from the light-emitting layer 16 is reflected by the reflective layer 14, and at least a light from the light-emitting layer 16 and a light from the reflective layer 14 are transmitted through the surface layer 18, so that a light is emitted from the surface layer 18.

The reflective layer 14 has a stack structure containing a high refractive layer and a low refractive layer composed of AlGaAs. Of course the reflective layer 14 may be an Al metal layer. The light-emitting layer 16 has a thickness of 1.5 μm to 5.0 mm, and contains an n-AlGaAs layer (a lower cladding layer), an AlGaAs layer (an active layer), and a p-AlGaAs layer (an upper cladding layer).

The surface layer 18 is formed by alternately stacking low refractive films 18a and high refractive films 18b (films having refractive indices higher than those of the low refractive films 18a). The surface layer 18 may be formed by alternately stacking one low refractive film 18a and one high refractive film 18b. The outermost film in the surface layer 18 may be the low refractive film 18a. The film adjacent to the light-emitting layer 16 in the surface layer 18 may be the high refractive film 18b.

The low refractive film 18a may be composed of a material having a refractive index of about 1.3 to 1.5 at the emission wavelength (e.g. 780 nm). Examples of the materials include silicon dioxide (SiO₂), MgF₂, BaF₂, LiF, SiF₂, AlF₃, NaF, and mixtures of two or more thereof.

The high refractive film 18b may be composed of a material having a refractive index of about 1.8 to 2.5 at the emission wavelength (e.g. 780 nm). Examples of the materials include silicon nitride (Si₃N₄), titanium oxide (TiO₂), tantalum oxide (Ta₂O₅), hafnium oxide (HfO₂), and zirconium oxide (ZrO₂).

It is particularly preferred that the low refractive film 18a is composed of SiO₂ and the high refractive film 18b is composed of Si₃N₄. In this case, the low refractive films 18a and the high refractive films 18b can be alternately formed in a common film forming apparatus without taking out a workpiece having the light-emitting layer 16 on the GaAs substrate 12 from the apparatus during the formation of the surface layer 18.

The reflective layer 14 and the light-emitting layer 16 may be formed on the GaAs substrate 12 by epitaxial growth. The low refractive films 18a and the high refractive films 18b for the surface layer 18 may be formed by vacuum vapor deposition, sputtering, or plasma CVD. The plasma CVD is preferred from the viewpoints of the denseness and durability of the film.

### EXAMPLES

### First Example

First Example for evaluating wavelength dependence and temperature dependence of emission light amount in Comparative Example and Example will be described below.

### Comparative Example

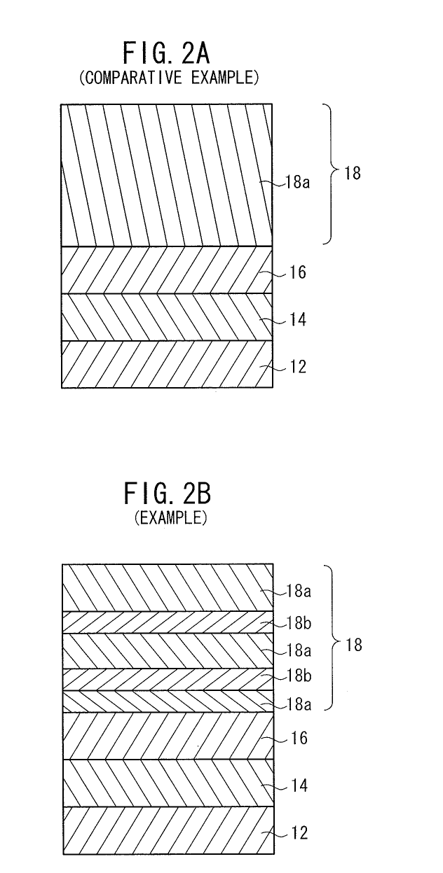

In Comparative Example, as shown in FIG. 2A, only an SiO₂ film 18a was formed as a surface layer 18 on a light-emitting layer 16. Thus, the surface layer 18 had a single layer structure. The SiO₂ film 18a had a thickness of 680 nm.

### Example

In Example, as shown in FIG. 2B, a surface layer 18 having a five-film structure was formed on a light-emitting layer 16. A 50-nm-thick SiO₂ film 18a, a 52-nm-thick SiN film 18b (SiN means Si₃N₄, also in the following description), a 113-nm-thick SiO₂ film 18a, a 85-nm-thick SiN film 18b, and a 380-nm-thick SiO₂ film 18a were stacked in this order as a first film (a film adjacent to the light-emitting layer 16) to a fifth film (an outermost film).

(Process for Forming Surface Layer)

The SiO₂ films 18a and the SiN films 18b were formed by plasma CVD. Specifically, the surface layer 18 was formed on the light-emitting layer 16 using a sputtering phenomenon of a plasma generated by a high-frequency wave (13.56 MHz) and an RF power (up to 3000 W). This layer formation process is described below.

The SiN film 18b can be formed from a source gas containing a silane (SiH₄), nitrogen (N₂), and ammonia (NH₃). As shown in Table 1, the silane (SiH₄), ammonia (NH₃), and nitrogen (N₂) were supplied at gas flow rates of 40 sccm, 40 sccm, and 2000 sccm, respectively, so that an SiN film having a refractive index of 1.9 at an emission wavelength of 780 nm was formed at a film formation rate of 166.9 (nm/minute). Parameters such as the flow rate ratio between SiH₄ and NH₃, RF power, and film formation pressure were selected to control the film stress, thickness uniformity, film formation rate, and refractive index.

TABLE 1

| | | | | Film | | |
|---|---|---|---|---|---|---|
| | | | RF | Formation | | Substrate |
| SiH₄ | NH₃ | N₂ | Power | Pressure | Vacuum Degree | Temperature |
| (SCCM) | (SCCM) | (SCCM) | (W) | (Pa) | (Pa) | (° C.) |
| 40 | 40 | 2000 | 300 | 240 | 5 × 10⁻³ | 300 |

The SiO₂ film 18a can be formed from a source gas containing a silane (SiH₄), nitrogen monoxide (N₂O), and oxygen (O₂), or from a combination of a source liquid containing tetraethoxysilane (TEOS) and a source gas containing oxygen (O₂). In this example, the SiO₂ film 18a was formed using the combination of the source liquid containing tetraethoxysilane (TEOS) and the source gas containing oxygen (O₂). As shown in Table 2, the tetraethoxysilane (TEOS) and oxygen (O₂) were supplied at gas flow rates of 20 sccm and 680 sccm, respectively, so that an SiO₂ film 18a having a refractive index of 1.46 at an emission wavelength of 780 nm was formed. Parameters such as the flow rate ratio between TEOS and O₂, RF power, and film formation pressure were selected to control the film stress, thickness uniformity, and film formation rate. As described above, the combination of the SiN films 18b and the SiO₂ films 18a can be formed in a common plasma CVD apparatus.

TABLE 2

| | | | Film | | |
|---|---|---|---|---|---|
| | | RF | Formation | Vacuum | Substrate |
| TEOS | O₂ | Power | Pressure | Degree | Temperature |
| (SCCM) | (SCCM) | (W) | (Pa) | (Pa) | (° C.) |
| 20 | 680 | 500 | 30 | 5 × 10⁻³ | 80 |

### (Evaluation: Comparative Example)

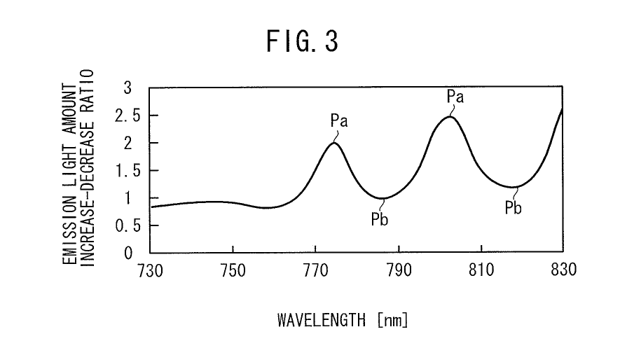

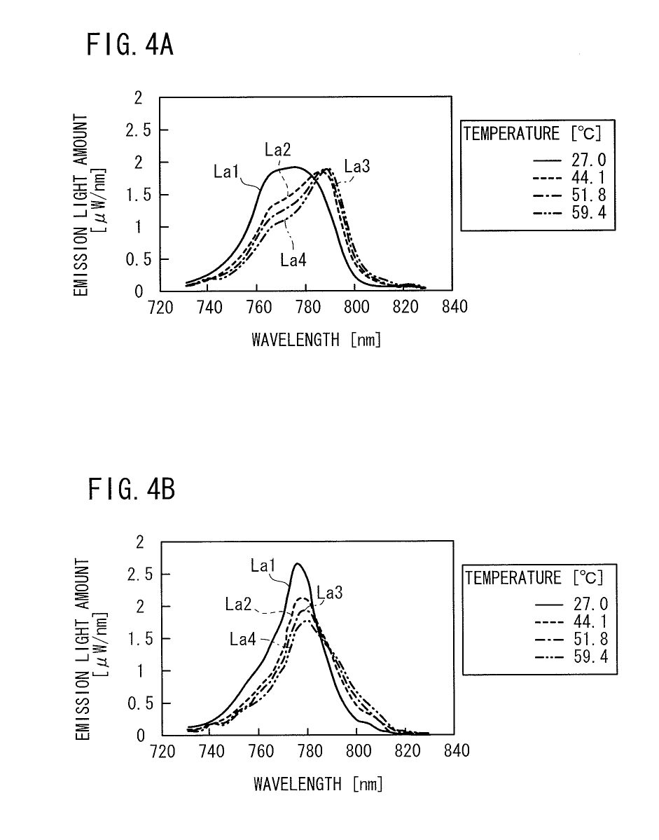

Measurement results of Comparative Example are shown in FIGS. 3 to 4B. FIG. 3 shows the emission light amount increase-decrease ratio depending on the emission wavelength. FIG. 4A shows the emission light amount change depending on the emission wavelength in a case where the overall thickness of the light-emitting device (the total thickness of the GaAs substrate 12, reflective layer 14, light-emitting layer 16, and surface layer 18) was 1% smaller than the predetermined thickness (particularly in the center). FIG. 4B shows the emission light amount change depending on the emission wavelength in a case where the overall thickness of the light-emitting device was 1% larger than the predetermined thickness (particularly in the center). Thus, the emission spectra of the light-emitting device of Comparative Example can be evaluated by using FIGS. 4A and 4B in relation to the change in overall thickness by 2%. In FIGS. 4A and 4B, the continuous line La1 represents a property at a usage environment temperature of 27.0° C., the dashed line La2 represents a property at 44.1° C., the one-dot chain line La3 represents a property at 51.8° C., and the two-dot chain line La4 represents a property at 59.4° C.

As shown in FIG. 3, maximal peaks Pa at the emission light amount increase-decrease ratio of 2 or more and minimal peaks Pb at the increase-decrease ratio of approximately 1 are observed alternately at a particular distance. It is clear therefrom that the light-emitting device of Comparative Example exhibits a highly wavelength-dependent emission light amount. This is because the light-emitting device of Comparative Example has the surface layer 18 composed of only the SiO₂ film, which has an average reflectance (a ratio of light reflected to the light-emitting layer 16) of about 10% in an emission wavelength range of 730 to 830 nm. Thus, a light emitted upward from the light-emitting layer 16 is reflected by an interface between an air space and the surface layer 18 or between the light-emitting layer 16 and the surface layer 18, and the reflected light resonates with a light emitted downward from the light-emitting layer 16, whereby the emission from the light-emitting layer 16 has a plurality of peak wavelengths (at which the maximal peaks Pa of the emission light amount were observed). Particularly when the light-emitting layer 16 has a thickness of 1.5 μm or more, the plural peak wavelengths are frequently observed.

Furthermore, as shown in FIG. 4A, the peak wavelength is greatly changed depending on the environment temperature increase from 27° C. to 59.4° C. In addition, as shown in FIGS. 4A and 4B, the peak wavelength is greatly changed depending also on the change in overall light-emitting device thickness by 2%.

It is clear therefrom that in the light-emitting device of Comparative Example, the peak wavelength is shifted by the slight thickness nonuniformity caused in the production process and the slight usage environment temperature change. In addition, the specific peak wavelength of the light-emitting device is shifted to the long-wavelength side also by the refractive index change and the thickness increase of the material due to the increase of the usage environment temperature.

Thus, in Comparative Example, the light-emitting devices vary widely in the emission light amount. When such devices are used in a display or an exposure apparatus having a plurality of light-emitting portions, it is difficult to obtain an approximately uniform emission light amount over the entire display or exposure surface.

### (Evaluation: Example)

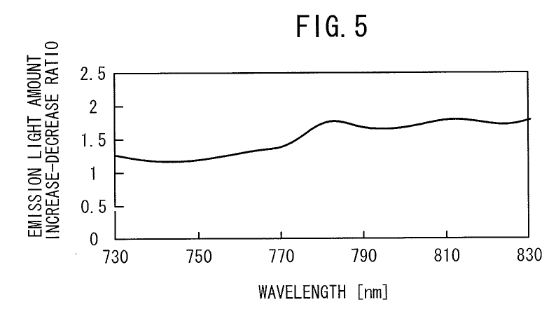

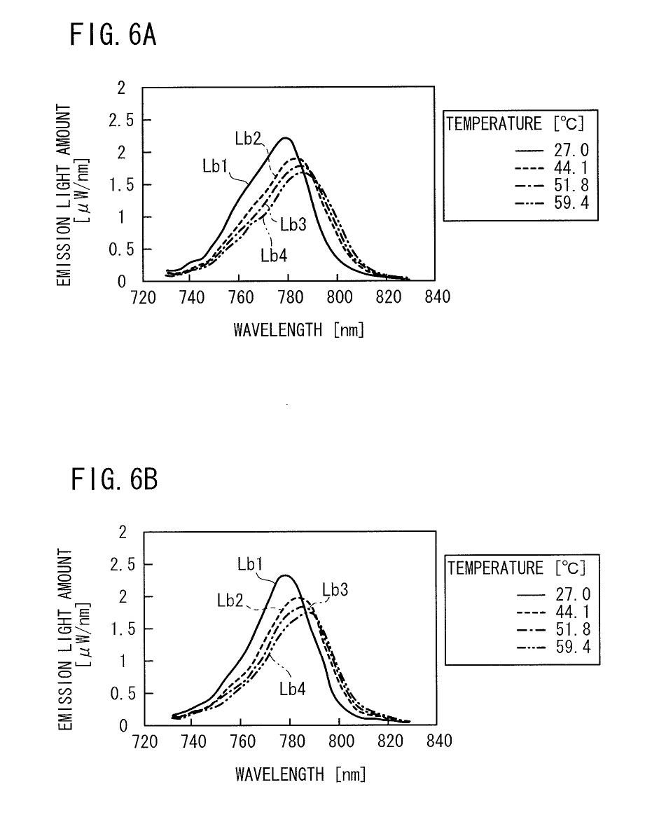

Measurement results of Example are shown in FIGS. 5 to 6B. FIG. 5 shows the emission light amount increase-decrease ratio depending on the emission wavelength. FIG. 6A shows the emission light amount change depending on the emission wavelength in a case where the overall thickness of the light-emitting device (the total thickness of the GaAs substrate 12, reflective layer 14, light-emitting layer 16, and surface layer 18) was 1% smaller than the predetermined thickness. FIG. 6B shows the emission light amount change depending on the emission wavelength in a case where the overall thickness of the light-emitting device was 1% larger than the predetermined thickness. Thus, the emission spectra of the light-emitting device of Example can be evaluated by using FIGS. 6A and 6B in relation to the change in overall thickness by 2%. In FIGS. 6A and 6B, the continuous line Lb1 represents a property at a usage environment temperature of 27.0° C., the dashed line Lb2 represents a property at 44.1° C., the one-dot chain line Lb3 represents a property at 51.8° C., and the two-dot chain line Lb4 represents a property at 59.4° C.

As shown in FIG. 5, the light-emitting device of Example has an approximately constant emission light amount increase-decrease ratio with a small peak at 780 nm. It is clear therefrom that the light-emitting device exhibits a low-wavelength-dependent emission light amount. Small peaks are observed not only at 780 nm but also at 800 to 830 nm, whereby the increase-decrease ratio is considered to have substantially no peaks in the entire wavelength region. This is because the light-emitting device of Example has the surface layer 18 composed of the combination of the low refractive films 18a and the high refractive films 18b, which has a lowered average reflectance (a ratio of light reflected to the light-emitting layer 16) of 0.5% to 3% to prevent the above resonance. This tendency is observed when the light-emitting layer 16 has a thickness of 1.5 μm to 5.0 mm.

Furthermore, as shown in FIGS. 6A and 6B, the peak wavelength is changed only by at most 5 nm depending on the environment temperature increase from 27° C. to 59.4° C. or on the change in overall light-emitting device thickness by 2%.

Therefore, the light-emitting device of Example has substantially no peak wavelengths as observed in Comparative Example, whereby the emission light amount variation is hardly caused due to the thickness nonuniformity caused in the production process and the usage environment temperature change.

Thus, in Example, the emission light amount variation among the light-emitting devices can be reduced in use, and the yield and quality of the device per se can be improved. For example, when the light-emitting device 10 of Example is used in a display or an exposure apparatus having a plurality of light-emitting portions, an approximately uniform emission light amount can be obtained over the entire display or exposure surface without light amount correction techniques. As a result, processes for detecting the emission property of each light-emitting portion are not needed, whereby the yield and quality of a product using the light-emitting device 10 can be improved, resulting in cost reduction of the products.

### Second Example

Second Example for evaluating transmittance change depending on emission wavelength in Comparative Example 1 and Examples 1 to 4 will be described below. In surface layers 18 of Examples 1 to 4, a film adjacent to a light-emitting layer 16 was a low refractive film 18a.

### Comparative Example 1

Only a 680-nm-thick SiO₂ film 18a was formed as a surface layer 18 on a light-emitting layer 16.

### Example 1

The surface layer 18 had a two-film structure containing the first film of a 50-nm-thick SiO₂ film 18a and the second film of a 633-nm-thick SiN film 18b.

### Example 2

The surface layer 18 had a three-film structure containing the first film of a 50-nm-thick SiO₂ film 18a, the second film of a 50-nm-thick SiN film 18b, and the third film of a 532-nm-thick SiO₂ film 18a.

### Example 3

The surface layer 18 had a four-film structure containing the first film of a 50-nm-thick SiO₂ film 18a, the second film of a 78-nm-thick SiN film 18b, the third film of a 114-nm-thick SiO₂ film 18a, and the fourth film of a 448-nm-thick SiN film 18b.

### Example 4

The surface layer 18 had a five-film structure containing the first film of a 50-nm-thick SiO₂ film 18a, the second film of a 52-nm-thick SiN film 18b, the third film of a 113-nm-thick SiO₂ film 18a, the fourth film of a 85-nm-thick SiN film 18b, and the fifth film of a 380-nm-thick SiO₂ film 18a.

### (Evaluation)

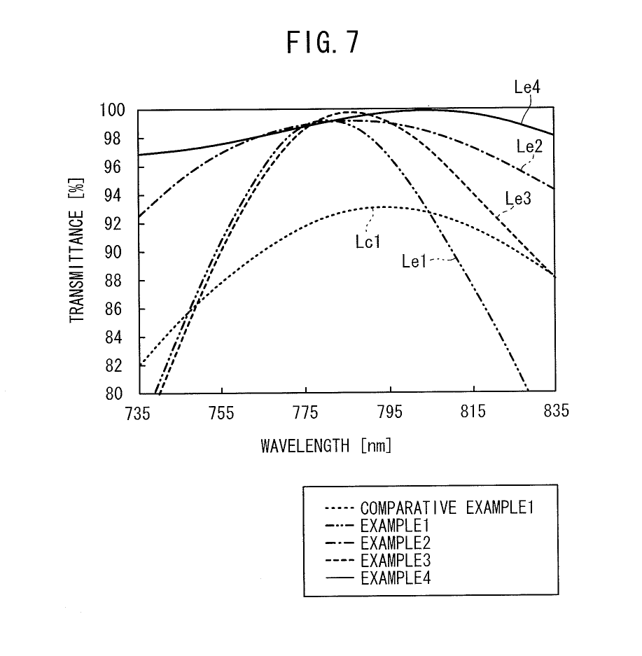

The transmittance changes of Comparative Example 1 and Examples 1 to 4 depending on the emission wavelength are shown in FIG. 7. In FIG. 7, the dotted line Lc1 represents a property of Comparative Example 1, the two-dot chain line Le1 represents a property of Example 1, the one-dot chain line Le2 represents a property of Example 2, the dashed line Le3 represents a property of Example 3, and the continuous line Le4 represents a property of Example 4.

As shown in FIG. 7, in Comparative Example 1, the transmittance was 93% at an emission wavelength of 780 nm, and the transmittance change was 82% to 93% in a wavelength range of 735 to 835 nm.

In contrast, in Examples 1 to 4, the transmittance was approximately 99% at the emission wavelength of 780 nm. Particularly in Examples 2 and 4, lower-wavelength-dependent transmittances were observed, and the transmittance changes were 93% to 99% and 97% to 99.90%, respectively in the wavelength range of 735 to 835 nm. Thus, the transmittance at the emission wavelength of 780 nm was higher in Examples 1 to 4 than in Comparative Example 1. In Examples 1 to 4, particularly in the case of using the low refractive film 18a as the outermost film of the surface layer 18, an approximately uniform emission light amount can be obtained even when the emission wavelength is changed due to the thickness nonuniformity caused in the production process and the usage environment temperature change.

### Third Example

Third Example for evaluating transmittance change depending on emission wavelength in Comparative Example 1 and Examples 5 to 8 will be described below. In surface layers 18 of Examples 5 to 8, a film adjacent to a light-emitting layer 16 was a high refractive film 18b.

### Comparative Example 1

As described above, only a 680-nm-thick SiO₂ film 18a was formed as a surface layer 18 on a light-emitting layer 16.

### Example 5

The surface layer 18 had a two-film structure containing the first film of a 98-nm-thick SiN film 18b and the second film of a 534-nm-thick SiO₂ film 18a.

### Example 6

The surface layer 18 had a three-film structure containing the first film of a 110-nm-thick SiN film 18b, the second film of a 225-nm-thick SiO₂ film 18a, and the third film of a 396-nm-thick SiN film 18b.

### Example 7

The surface layer 18 had a four-film structure containing the first film of a 98-nm-thick SiN film 18b, the second film of a 134-nm-thick SiO₂ film 18a, the third film of a 98-nm-thick SiN film 18b, and the fourth film of a 402-nm-thick SiO₂ film 18a.

### Example 8

The surface layer 18 had a five-film structure containing the first film of a 98-nm-thick SiN film 18b, the second film of a 134-nm-thick SiO₂ film 18a, the third film of a 92-nm-thick SiN film 18b, the fourth film of a 128-nm-thick SiO₂ film 18a, and the fifth film of a 198-nm-thick SiN film 18b.

### (Evaluation)

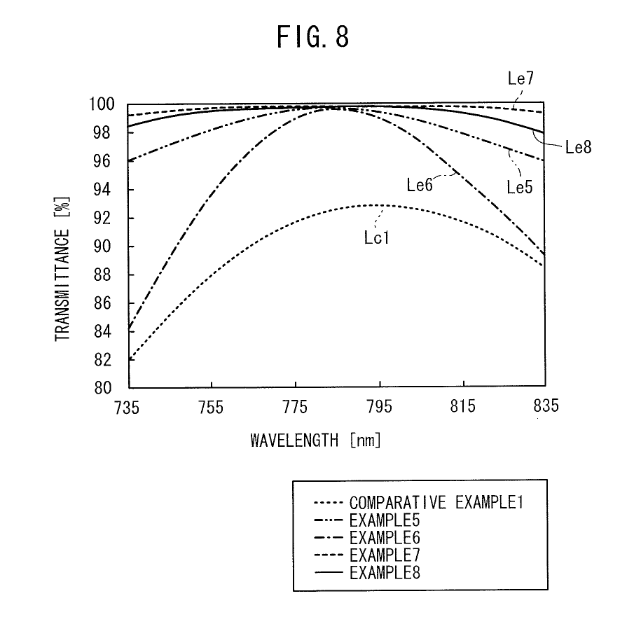

The transmittance changes of Comparative Example 1 and Examples 5 to 8 depending on the emission wavelength are shown in FIG. 8. In FIG. 8, the dotted line Lc1 represents a property of Comparative Example 1, the two-dot chain line Le5 represents a property of Example 5, the one-dot chain line Le6 represents a property of Example 6, the dashed line Le7 represents a property of Example 7, and the continuous line Le8 represents a property of Example 8.

As shown in FIG. 8, in Comparative Example 1, the transmittance was 93% at an emission wavelength of 780 nm, and the transmittance change was 82% to 93% in a wavelength range of 735 to 835 nm.

In contrast, in Examples 5 to 8, the transmittance was approximately 99.9% at the emission wavelength of 780 nm. Particularly in Examples 5, 7, and 8, lower-wavelength-dependent transmittances were observed, and the transmittance changes were 96% to 99.9%, 99.5% to 99.9%, and 99% to 99.9%, respectively, in the wavelength range of 735 to 835 nm. It is to be understood that the wavelength dependence of the transmittance was lower in Example 6 than in Comparative Example 1, the transmittance change of Example 6 being 84% to 99.9% in the wavelength range of 735 to 835 nm.

Thus, the higher transmittance at the emission wavelength of 780 nm and the lower wavelength dependence of the transmittance were achieved in Examples by using the high refractive film 18b as the film adjacent to the light-emitting layer 16, as compared to Comparative Example 1. Particularly in the case of using the low refractive film 18a as the outermost film of the surface layer 18, the wavelength dependence of the transmittance can be further lowered, and an approximately uniform emission light amount can be obtained even when the emission wavelength is changed due to the thickness nonuniformity caused in the production process and the change in usage environment temperature.

### Fourth Example

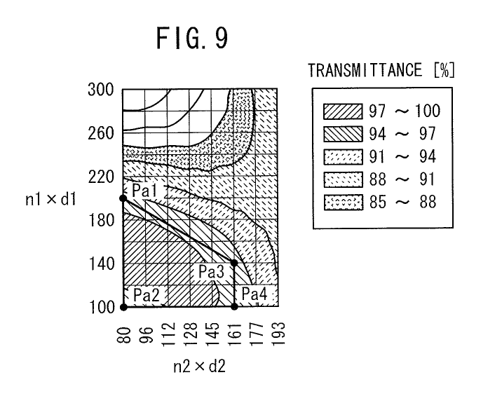

In Example 9, a surface layer 18 having a two-film structure was formed on a light-emitting layer 16. A high refractive film 18b (an SiN film) and a low refractive film 18a (an SiO₂ film) were stacked in this order as a first film and a second film (an outermost film). The transmittance distribution of the surface layer 18 was obtained using parameters of the optical path lengths of the first and second films (FIGS. 9 to 12), and a preferred optical path length range of the first and second films was determined. The preferred range means a range in which the surface layer reliably has a transmittance of 94% or more and a region with a transmittance of 97% or more is contained.

When the first film has a refractive index of n1 and a thickness of d1, the first film has an optical path length of n1×d1. When the second film has a refractive index of n2 and a thickness of d2, the second film has an optical path length of n2×d2.

The transmittance of the surface layer 18 depends on the synergy between the light amplitude and phase in each film therein. The transmittance is determined by the refractive index and thickness of each film forming the surface layer 18. When the refractive index difference between the low refractive film 18a and the high refractive film 18b is largely changed, also the transmittance is largely changed. However, in the light-emitting device, the refractive indices n of materials usable for the high refractive film 18b and the low refractive film 18a of a light-emitting device are limited to approximately 1.8 to 2.1 and 1.38 to 1.5, respectively. Thus, the refractive index difference falls within a range of 0.4 to 0.6. In the case of using the SiN and SiO₂ films having a refractive index difference of 0.53, the parameter ranges of the light-emitting device can be approximately completely obtained by determining conditions required for obtaining a high effect.

In FIG. 9, the ordinate represents the optical path length n1×d1 of the first film, and the abscissa represents the optical path length n2×d2 of the second film. As shown in FIG. 9, in an area with n1×d1 of 100 to 300 and n2×d2 of 80 to 193, a range enclosed by the following coordinates Pa1 to Pa4 is considered as the preferred range.
Pa1=(n1×d1, n2×d2)=(200, 80)
Pa2=(n1×d1, n2×d2)=(100, 80)
Pa3=(n1×d1, n2×d2)=(140, 161)
Pa4=(n1×d1, n2×d2)=(100, 161)

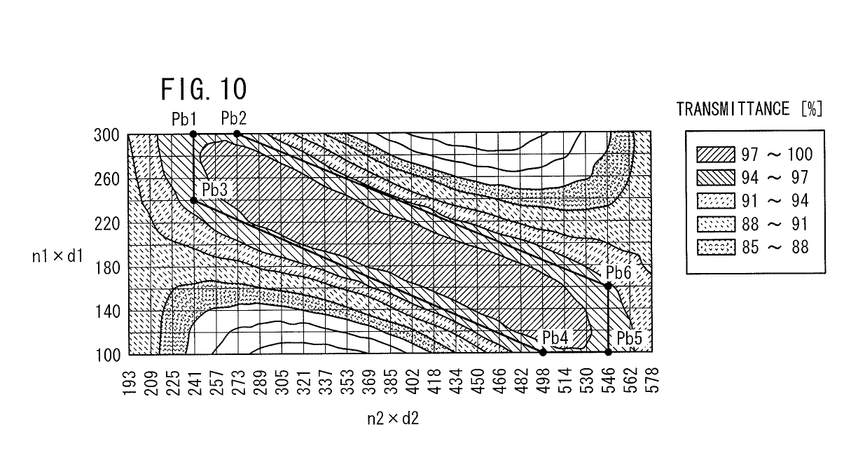

As shown in FIG. 10, in an area with n1×d1 of 100 to 300 and n2×d2 of 193 to 578, a range enclosed by the following coordinates Pb1 to Pb6 is considered as the preferred range.
Pb1=(n1×d1, n2×d2)=(300, 241)
Pb2=(n1×d1, n2×d2)=(300, 273)
Pb3=(n1×d1, n2×d2)=(240, 241)
Pb4=(n1×d1, n2×d2)=(100, 498)
Pb5=(n1×d1, n2×d2)=(100, 546)
Pb6=(n1×d1, n2×d2)=(160, 546)

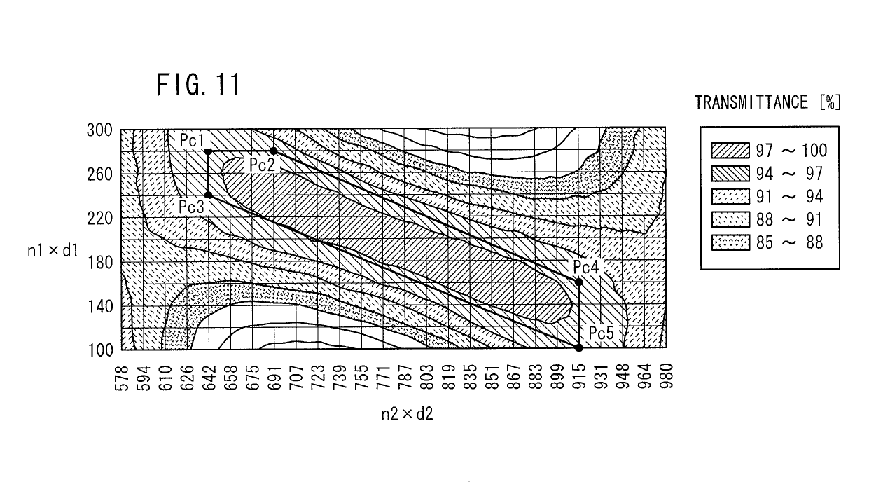

As shown in FIG. 11, in an area with n1×d1 of 100 to 300 and n2×d2 of 578 to 980, a range enclosed by the following coordinates Pc1 to Pc5 is considered as the preferred range.
Pc1=(n1×d1, n2×d2)=(280, 642)
Pc2=(n1×d1, n2×d2)=(280, 691)
Pc3=(n1×d1, n2×d2)=(240, 642)
Pc4=(n1×d1, n2×d2)=(160, 915)
Pc5=(n1×d1, n2×d2)=(100, 915)

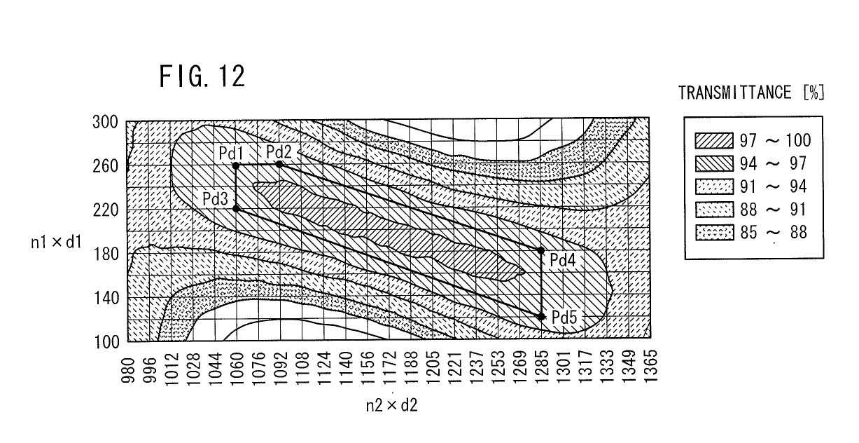

As shown in FIG. 12, in an area with n1×d1 of 100 to 300 and n2×d2 of 980 to 1365, a range enclosed by the following coordinates P d1 to Pd5 is considered as the preferred range.
P d1=(n1×d1, n2×d2)=(260, 1060)
Pd2=(n1×d1, n2×d2)=(260, 1092)
Pd3=(n1×d1, n2×d2)=(220, 1060)
Pd4=(n1×d1, n2×d2)=(180, 1285)
Pd5=(n1×d1, n2×d2)=(120, 1285)

### Fifth Example

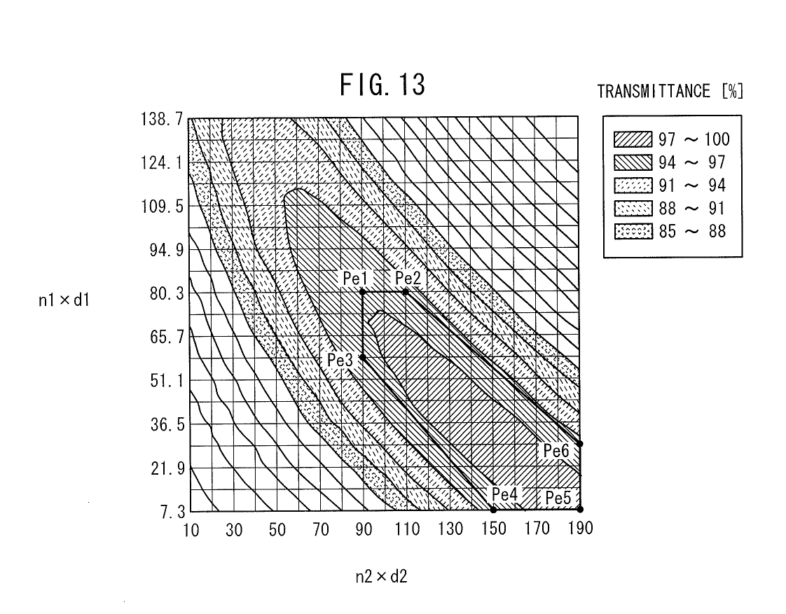

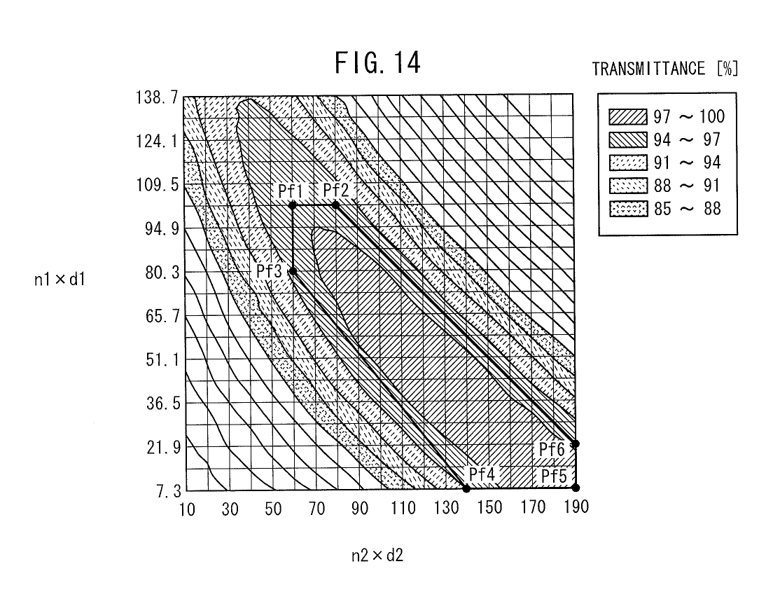

In Example 10, a surface layer having a three-film structure was formed on a light-emitting layer. A low refractive film (an SiO₂ film), a high refractive film (an SiN film), and a low refractive film (an SiO₂ film) were stacked in this order as a first film, a second film and a third film (an outermost film). The optical path length n3×d3 of the outermost third film was controlled at approximately ½ of the emission wavelength of 780 nm or a multiple thereof. The transmittance distribution of the surface layer was obtained using parameters of the optical path lengths n1×d1 and n2×d2 of the first and second films (FIGS. 13 and 14), and a preferred optical path length range of the first and second films was determined. The preferred range means a range in which the surface layer reliably has a transmittance of 94% or more and a region with a transmittance of 97% or more is contained, in the same manner as Fourth Example.

The thickness of the third film was controlled at approximately 530 nm to obtain an optical path length n3×d3 of 777. In FIG. 13, the ordinate represents the optical path length n1×d1 of the first film, and the abscissa represents the optical path length n2×d2 of the second film. As shown in FIG. 13, in an area with n1×d1 of 7.3 to 138.7 and n2×d2 of 10 to 190, a range enclosed by the following coordinates Pe1 to Pe6 is considered as the preferred range.
Pe1=(n1×d1, n2×d2)=(80.3, 90.0)
Pe2=(n1×d1, n2×d2)=(80.3, 110.0)
Pe3=(n1×d1, n2×d2)=(58.4, 90.0)
Pe4=(n1×d1, n2×d2)=(7.3, 150.0)
Pe5=(n1×d1, n2×d2)=(7.3, 190.0)
Pe6=(n1×d1, n2×d2)=(29.2, 190.0)

Furthermore, the thickness of the third film was controlled at approximately 270 nm to obtain an optical path length n3×d3 of 394. In FIG. 14, the ordinate represents the optical path length n1×d1 of the first film, and the abscissa represents the optical path length n2×d2 of the second film. As shown in FIG. 14, in an area with n1×d1 of 7.3 to 138.7 and n2×d2 of 10 to 190, a range enclosed by the following coordinates Pf1 to Pf6 is considered as the preferred range.
Pf1=(n1×d1, n2×d2)=(102.2, 60.0)
Pf2=(n1×d1, n2×d2)=(102.2, 80.0)
Pf3=(n1×d1, n2×d2)=(80.3, 60.0)
Pf4=(n1×d1, n2×d2)=(7.3, 140.0)
Pf5=(n1×d1, n2×d2)=(7.3, 190.0)
Pf6=(n1×d1, n2×d2)=(21.9, 190.0)

### Sixth Example

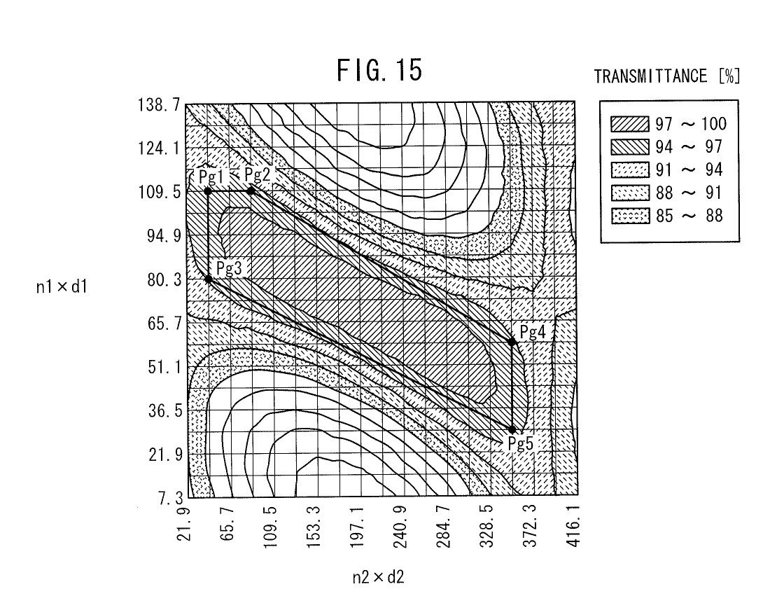

In Example 11, a surface layer having a four-film structure was formed on a light-emitting layer. A high refractive film (an SiN film), a low refractive film (an SiO₂ film), a high refractive film (an SiN film), and a low refractive film (an SiO₂ film) were stacked in this order as a first film, a second film, a third film and a fourth film (an outermost film). The sum (n4×d4+n3×d3) of the optical path lengths n4×d4 and n3×d3 of the outermost fourth film and the third film was controlled approximately equal to the emission wavelength of 780 nm. The transmittance distribution of the surface layer was obtained using parameters of the optical path lengths n1×d1 and n2×d2 of the first and second films (FIG. 15), and a preferred optical path length range of the first and second films were determined. The preferred range means a range in which the surface layer reliably has a transmittance of 94% or more and a region with a transmittance of 97% or more is contained, in the same manner as Fourth Example.

The optical path lengths n4×d4 and n3×d3 of the fourth and third films were controlled at 584 and 196, respectively. In FIG. 15, the ordinate represents the optical path length n1×d1 of the first film, and the abscissa represents the optical path length n2×d2 of the second film. As shown in FIG. 15, in an area with n1×d1 of 7.3 to 138.7 and n2×d2 of 21.9 to 416.1, a range enclosed by the following coordinates Pg1 to Pg5 is considered as the preferred range.
Pg1=(n1×d1, n2×d2)=(109.5, 43.8)
Pg2=(n1×d1, n2×d2)=(109.5, 87.6)
Pg3=(n1×d1, n2×d2)=(80.3, 43.8)
Pg4=(n1×d1, n2×d2)=(58.4, 350.4)
Pg5=(n1×d1, n2×d2)=(29.2, 350.4)

### Seventh Example

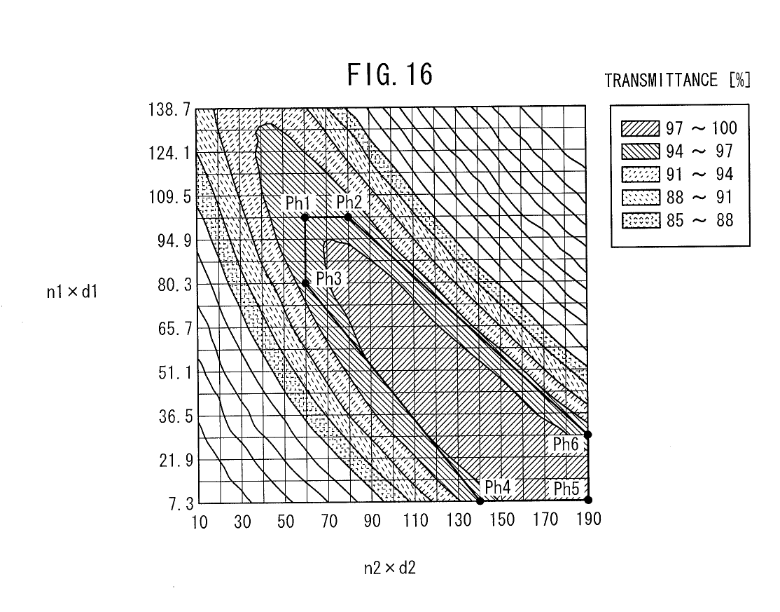

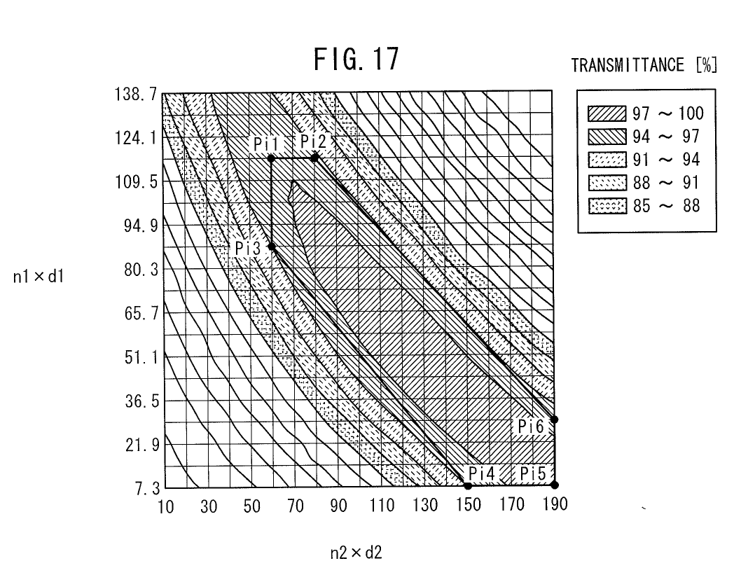

In Example 12, a surface layer having a five-film structure was formed on a light-emitting layer. A low refractive film (an SiO₂ film), a high refractive film (an SiN film), a low refractive film (an SiO₂ film), a high refractive film (an SiN film), and a low refractive film (an SiO₂ film), were stacked in this order as a first film, a second film, a third film, a fourth film and a fifth film (an outermost film). The sum (n5×d5+n4×d4) of the optical path lengths n5×d5 and n4×d4 of the outermost fifth film and the fourth film was controlled approximately equal to the emission wavelength of 780 nm, and the optical path length n3×d3 of the third film was controlled at approximately ¼ of the emission wavelength of 780 nm. The transmittance distribution of the surface layer was obtained using parameters of the optical path lengths n1×d1 and n2×d2 of the first and second films (FIGS. 16 and 17), and a preferred optical path length range of the first and second films were determined. The preferred range means a range in which the surface layer reliably has a transmittance of 94% or more and a region with a transmittance of 97% or more is contained, in the same manner as Fourth Example.

The optical path lengths n5×d5, n4×d4, and n3×d3 of the fifth, fourth, and third films were controlled at 584, 196, and 195, respectively. In FIG. 16, the ordinate represents the optical path length n1×d1 of the first film, and the abscissa represents the optical path length n2×d2 of the second film. As shown in FIG. 16, in an area with n1×d1 of 7.3 to 138.7 and n2×d2 of 10 to 190, a range enclosed by the following coordinates Ph1 to Ph5 is considered as the preferred range.
Ph1=(n1×d1, n2×d2)=(102.2, 60.0)
Ph2=(n1×d1, n2×d2)=(102.2, 80.0)
Ph3=(n1×d1, n2×d2)=(80.3, 60.0)
Ph4=(n1×d1, n2×d2)=(7.3, 140.0)
Ph5=(n1×d1, n2×d2)=(7.3, 190.0)
Ph6=(n1×d1, n2×d2)=(29.2, 190.0)

Furthermore, the optical path lengths n5×d5, n4×d4, and n3×d3 of the fifth, fourth, and third films were controlled at 555, 170, and 165, respectively. In FIG. 17, the ordinate represents the optical path length n1×d1 of the first film, and the abscissa represents the optical path length n2×d2 of the second film. As shown in FIG. 17, in an area with n1×d1 of 7.3 to 138.7 and n2×d2 of 10 to 190, a range enclosed by the following coordinates Pi1 to Pi5 is considered as the preferred range.
Pi1=(n1×d1, n2×d2)=(116.8, 60.0)
Pi2=(n1×d1, n2×d2)=(116.8, 80.0)
Pi3=(n1×d1, n2×d2)=(87.6, 60.0)
Pi4=(n1×d1, n2×d2)=(7.3, 150.0)
Pi5=(n1×d1, n2×d2)=(7.3, 190.0)
Pi6=(n1×d1, n2×d2)=(29.2, 190.0)

It is to be understood that the light-emitting device of the present invention is not limited to the above embodiments, and various changes and modifications may be made therein without departing from the scope of the present invention.

What is claimed is:

1. A light-emitting device comprising a light-emitting layer, a reflective layer formed on one side of the light-emitting layer, and a surface layer formed on the other side of the light-emitting layer, wherein
a light from the light-emitting layer is reflected by the reflective layer, and at least a light from the light-emitting layer and a light from the reflective layer are transmitted through the surface layer, so that a light is emitted from the surface layer, and
the surface layer is formed by alternately stacking a low refractive film and a high refractive film having a refractive index higher than that of the low refractive film.

2. A light-emitting device according to claim 1, wherein the surface layer is formed by alternately stacking one low refractive film and one high refractive film.

3. A light-emitting device according to claim 1, wherein the light-emitting layer has a thickness of 1.5 μm to 5.0 mm.

4. A light-emitting device according to claim 1, wherein an outermost film in the surface layer is the low refractive film.

5. A light-emitting device according to claim 1, wherein in the surface layer a film adjacent to the light-emitting layer is the high refractive film.

6. A light-emitting device according to claim 1, wherein the surface layer may have a two-film structure containing a first film adjacent to the light-emitting layer, and a second film, the first film has an optical path length of n1×d1, the second film has an optical path length of n2×d2, and the optical path lengths of n1×d1 and n2×d2 are within a range enclosed by the following coordinates:
(n1×d1, n2×d2)=(300, 241);
(n1×d1, n2×d2)=(300, 273);
(n1×d1, n2×d2)=(240, 241);
(n1×d1, n2×d2)=(100, 498);
(n1×d1, n2×d2)=(100, 546); and
(n1×d1, n2×d2)=(160, 546).

7. A light-emitting device according to claim 1, wherein the surface layer may have a two-film structure containing a first film adjacent to the light-emitting layer, and a second film, the first film has an optical path length of n1×d1, the second film has an optical path length of n2×d2, and the optical path lengths of n1×d1 and n2×d2 are within a range enclosed by the following coordinates:
(n1×d1, n2×d2)=(280, 642);
(n1×d1, n2×d2)=(280, 691);
(n1×d1, n2×d2)=(240, 642);
(n1×d1, n2×d2)=(160, 915); and
(n1×d1, n2×d2)=(100, 915).

8. A light-emitting device according to claim 1, wherein the surface layer may have a two-film structure containing a first film adjacent to the light-emitting layer, and a second film, the first film has an optical path length of n1×d1, the second film has an optical path length of n2×d2, and the optical path lengths of n1×d1 and n2×d2 are within a range enclosed by the following coordinates:
(n1×d1, n2×d2)=(260, 1060);
(n1×d1, n2×d2)=(260, 1092);
(n1×d1, n2×d2)=(220, 1060);
(n1×d1, n2×d2)=(180, 1285); and
(n1×d1, n2×d2)=(120, 1285).

9. A light-emitting device according to claim 1, wherein the surface layer may have a two-film structure containing a first film adjacent to the light-emitting layer, and a second film, the first film has an optical path length of n1×d1, the second film has an optical path length of n2×d2, and the optical path lengths of n1×d1 and n2×d2 are within a range enclosed by the following coordinates:
(n1×d1, n2×d2)=(200, 80);
(n1×d1, n2×d2)=(100, 80);
(n1×d1, n2×d2)=(140, 161); and
(n1×d1, n2×d2)=(100, 161).

10. A light-emitting device according to claim 1, wherein the surface layer has a three-film structure containing first, second and third films, the first film being adjacent to the light-emitting layer, the first film has an optical path length of n1×d1, the second film has an optical path length of n2×d2, the optical path length of the third film is ½ of the emission wavelength or a multiple thereof, and the optical path lengths of n1×d1 and n2×d2 are within a range enclosed by the following coordinates:
(n1×d1, n2×d2)=(80.3, 90.0);
(n1×d1, n2×d2)=(80.3, 110.0);
(n1×d1, n2×d2)=(58.4, 90.0);
(n1×d1, n2×d2)=(7.3, 150.0);
(n1×d1, n2×d2)=(7.3, 190.0); and
(n1×d1, n2×d2)=(29.2, 190.0).

11. A light-emitting device according to claim 1, wherein the surface layer has a three-film structure containing first, second and third films, the first film being adjacent to the light-emitting layer, the first film has an optical path length of n1×d1, the second film has an optical path length of n2×d2, the optical path length of the third film is ½ of the emission wavelength or a multiple thereof, and the optical path lengths of n1×d1 and n2×d2 are within a range enclosed by the following coordinates:
(n1×d1, n2×d2)=(102.2, 60.0);
(n1×d1, n2×d2)=(102.2, 80.0);
(n1×d1, n2×d2)=(80.3, 60.0);
(n1×d1, n2×d2)=(7.3, 140.0);
(n1×d1, n2×d2)=(7.3, 190.0); and
(n1×d1, n2×d2)=(21.9, 190.0).

12. A light-emitting device according to claim 1, wherein the surface layer has a four-film structure containing a first film, a second film, a third film and a fourth film, the first film being adjacent to the light-emitting layer, the first film has an optical path length of n1×d1, the second film has an optical path length of n2×d2, a sum of optical path lengths of the third and fourth films is approximately equal to an emission wavelength, and the optical path lengths of n1×d1 and n2×d2 are within a range enclosed by the following coordinates:
(n1×d1, n2×d2)=(109.5, 43.8);
(n1×d1, n2×d2)=(109.5, 87.6);
(n1×d1, n2×d2)=(80.3, 43.8);
(n1×d1, n2×d2) (58.4, 350.4); and
(n1×d1, n2×d2)=(29.2, 350.4).

13. A light-emitting device according to claim 1, wherein the surface layer has a five-film structure containing a first film, a second film, a third film, a fourth film and a fifth film, the first film being adjacent to the light-emitting layer, the first film has an optical path length of n1×d1, the second film has an optical path length of n2×d2, the optical path length of the third film is approximately equal to ¼ of the emission wavelength, the sum of the optical path lengths of the fourth and fifth films is approximately equal to the emission wavelength, and the optical path lengths of n1×d1 and n2×d2 are within a range enclosed by the following coordinates:
(n1×d1, n2×d2)=(102.2, 60.0)
(n1×d1, n2×d2)=(102.2, 80.0)
(n1×d1, n2×d2)=(80.3, 60.0)
(n1×d1, n2×d2)=(7.3, 140.0)
(n1×d1, n2×d2)=(7.3, 190.0)
(n1×d1, n2×d2)=(29.2, 190.0)

14. A light-emitting device according to claim 1, wherein the surface layer has a five-film structure containing first to fifth films stacked in this order on the light-emitting layer, the first film has an optical path length of n1×d1, the second film has an optical path length of n2×d2, the optical path length of the third film is approximately equal to ¼ of the emission wavelength, the sum of the optical path lengths of the fourth and fifth films is approximately equal to the emission wavelength, and the optical path lengths of n1×d1 and n2×d2 are within a range enclosed by the following coordinates.
(n1×d1, n2×d2)=(116.8, 60.0)
(n1×d1, n2×d2)=(116.8, 80.0)
(n1×d1, n2×d2)=(87.6, 60.0)
(n1×d1, n2×d2)=(7.3, 150.0)
(n1×d1, n2×d2)=(7.3, 190.0)
(n1×d1, n2×d2)=(29.2, 190.0).
